(19) United States
(12) Patent Application Publication
(10) Pub. No.: US 2017/0110825 A1
(43) Pub. Date: Apr. 20, 2017

(54) Rugged Duralink Connector

(71) Applicant: Greg Cottrell, Arroyo Grande, CA (US)

(72) Inventor: Greg Cottrell, Arroyo Grande, CA (US)

(21) Appl. No.: 14/682,883

(22) Filed: Apr. 9, 2015

(51) Int. Cl. H01R 13/52

(52) U.S. Cl. CPC H01R 13/5213; H01R 13/5219

(57) ABSTRACT

A protective, waterproof cover for a standard Nexus type U-174 audio connector that has an outer cover on a male plug that seals over an outer surface of a female type U-92 A/U jack. The cover has an over jacket mold to cover and protect the jack at the connection. In addition the cover has a silicone O-ring at a base of the plug.

### BACKGROUND OF THE INVENTION

1. Field of the Invention

The present invention relates generally to covers for audio communication connectors.

2. Discussion of the Related Art

A standard type U-174 plug mates with a type U-92 A/U jack, a connection commonly used for Aviation and Off-road communications audio.

### BRIEF DESCRIPTION OF THE DRAWINGS

FIG. 1 is a perspective view of a U-174 plug, with a Rugged Duralink Connector, mated with a female U-92 A/U jack in one embodiment of the present invention.

FIG. 2 is a perspective view of the Rugged Duralink Connector.

### DETAILED DESCRIPTION

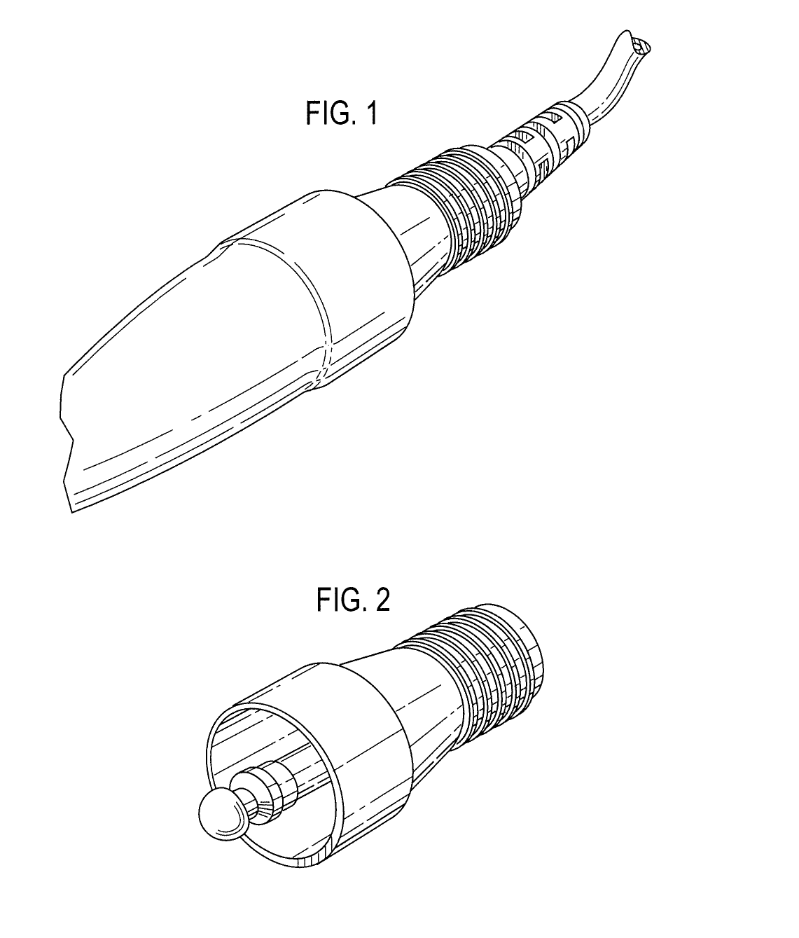

Referring first to FIG. 1, a perspective view of a standard U-174 plug (with a Rugged Duralink Connector) mated with a type U-92 A/U jack is shown. Referring next to FIG. 2, a perspective view of the U-174 plug with the Rugged Duralink connector is shown.

Water getting into an off-road connector makes the off-road vehicle intercom squeal. The solution was the development of the Rugged Duralink Connector (FIG. 2). The Rugged Duralink Connector has an over jacket mold to cover and protect the jack at the connection. In addition to the outer cover the Rugged Duralink Connector has a silicone O-ring at the base of the plug. Both the over jacket mold and the O-ring seal the connection point protecting it from water, mud and dirt which can affect audio performance. See FIGS. 1 and 2. The Rugged Duralink Connector protects the standard Nexus type U-174 plug. This plug type mates with the Amphenol Nexus type U-92 A/U jack (FIG. 1). This connection is commonly used for Aviation and Off-road communications audio.

1. A protective, waterproof cover for a U-174 connector, the connector configured to mate with a U-92 A/U female jack, that has an outer cover on a male plug of the connector that seals over an outer surface of the female jack.

2. The waterproof cover according to claim 1, wherein the cover seals to an outer cylinder of the female jack.

3. The waterproof cover according to claim 1, wherein the cover seals to a flat outer end of the female jack.

4. The waterproof cover according to claim 1, including an O-ring at a base of a male plug of the U-174 connector to ensure a waterproof seal.
